(19) United States
(12) Patent Application Publication
(10) Pub. No.: US 2026/0241419 A1
(43) Pub. Date: Aug. 20, 2026

(54) Multifunctional Cleaning Brush with Integrated Bottle Holster, Airflow Mechanism, and Bristle Base

(71) Applicant: Jon Marc Angelo Francisco, Los Angeles, CA (US)

(72) Inventor: Jon Marc Angelo Francisco, Los Angeles, CA (US)

(21) Appl. No.: 19/057,954

(22) Filed: Feb. 19, 2025

(51) Int. Cl. B08B 1/12; A46B 11/00

(52) U.S. Cl. CPC B08B 1/12; A46B 11/002

(57) ABSTRACT

The invention is a multifunctional cleaning brush with a hollow cylindrical body that serves as both a handle and a bottle holster for a cleaning solution container. It features an air pressure release mechanism near the base for smooth bottle insertion, a bristle base for cleaning, and a keyring attachment for portability. An optional elastic securing mechanism, such as a rubber band, O-ring, or equivalent feature, stabilizes the container within the hollow body. Constructed from durable materials like plastic or aluminum, the brush enables direct integration of the cleaning solution, allowing users to dispense and clean immediately. This compact and ergonomic tool streamlines the cleaning process, offering an integrated and portable solution for various surfaces, including sports equipment, industrial tools, footwear, and other applications requiring precise cleaning.

### BACKGROUND OF THE INVENTION

Traditional cleaning tools often require separate brushes and cleaning solution containers, leading to inefficiencies in usability and portability. Users, particularly those in outdoor and professional cleaning environments, benefit from integrated designs that combine a brush and cleaning solution. Existing tools either lack this integration or rely on internal water reservoirs, limiting their functionality.

The current invention overcomes these limitations by integrating a brush, a bottle holster, an air pressure release mechanism, and an elastic securing mechanism into a single, portable unit.

### SUMMARY OF THE INVENTION

A hollow cylindrical body serving as both a handle and a bottle holster.

A bristle base located at the bottom, optimized for cleaning various surfaces, including sports equipment, footwear, tools, and industrial items.

An air pressure release mechanism positioned near the bottom to facilitate smooth bottle insertion and secure placement.

An elastic securing mechanism, such as a rubber band, O-ring, or equivalent feature, that stabilizes the cleaning solution bottle within the hollow body.

A keyring attachment integrated at the top for portability.

Constructed from durable materials such as plastic or aluminum, the cleaning brush is suitable for long-term use in outdoor, industrial, and sports environments, providing users with a compact, efficient, and portable cleaning solution.

### BRIEF DESCRIPTION OF DRAWINGS

FIG. 1: Perspective view of the cleaning brush, illustrating the hollow cylindrical body (1), bottle holster opening (2), air pressure release hole (3), keyring attachment (4), bristle base (5), and bristles (6).

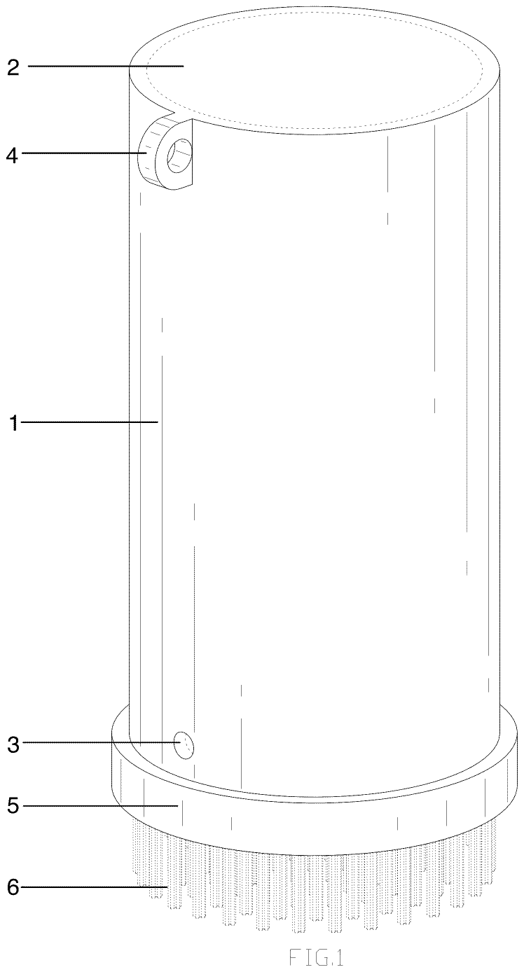

FIG. 2: Alternate perspective view of the cleaning brush, showing the hollow cylindrical body (1), bottle holster opening (2), air pressure release hole (3), keyring attachment (4), bristle base (5), and bristles (6).

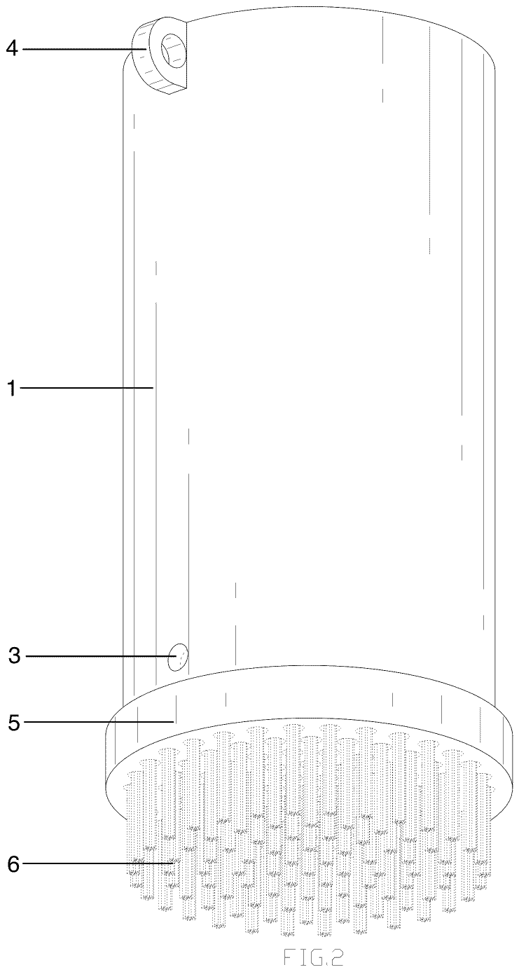

FIG. 3: Back view of the cleaning brush in an upright position, illustrating the hollow cylindrical body (1), air pressure release hole (3), keyring attachment (4), bristle base (5), and bristles (6).

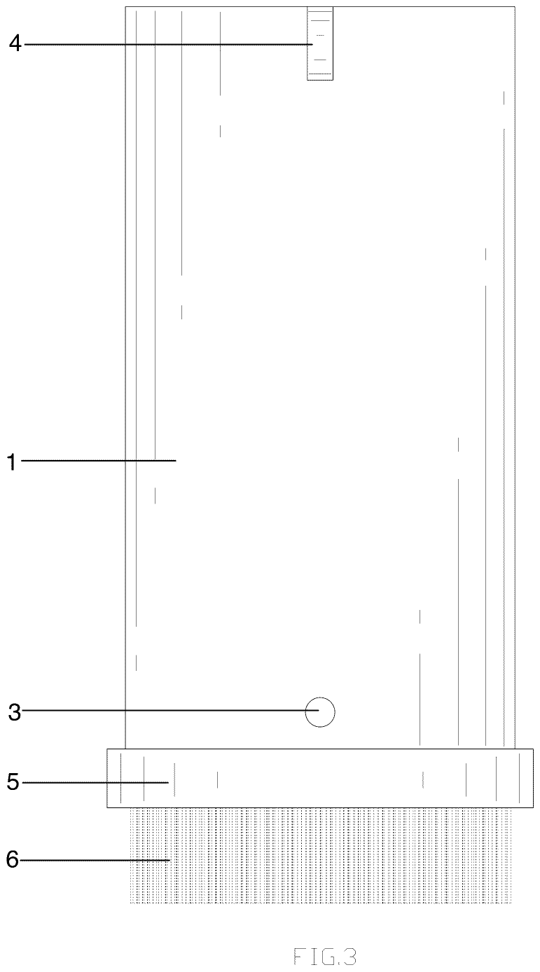

FIG. 4: Front view of the cleaning brush in an upright position, showing the hollow cylindrical body (1), bristle base (5), and bristles (6).

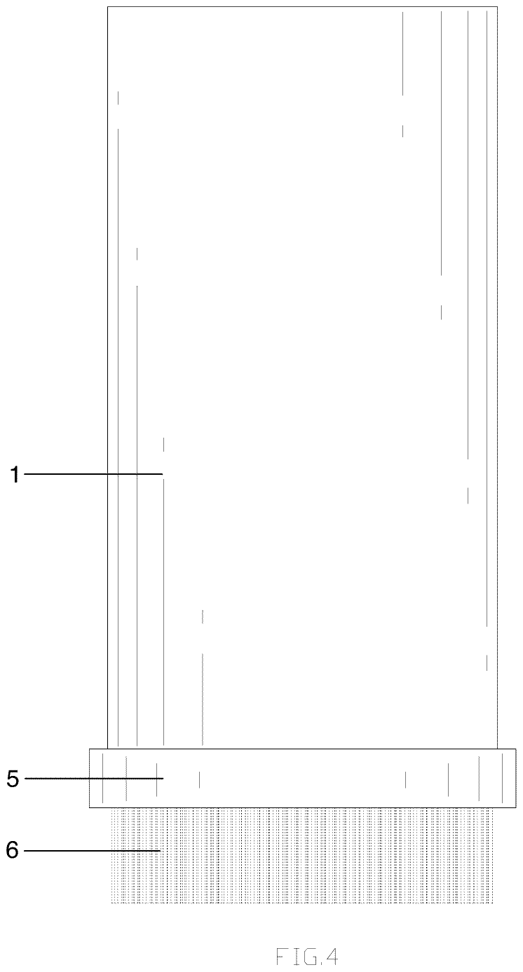

FIG. 5: Left-side view of the cleaning brush, illustrating the hollow cylindrical body (1), air pressure release hole (3), keyring attachment (4), bristle base (5), and bristles (6).

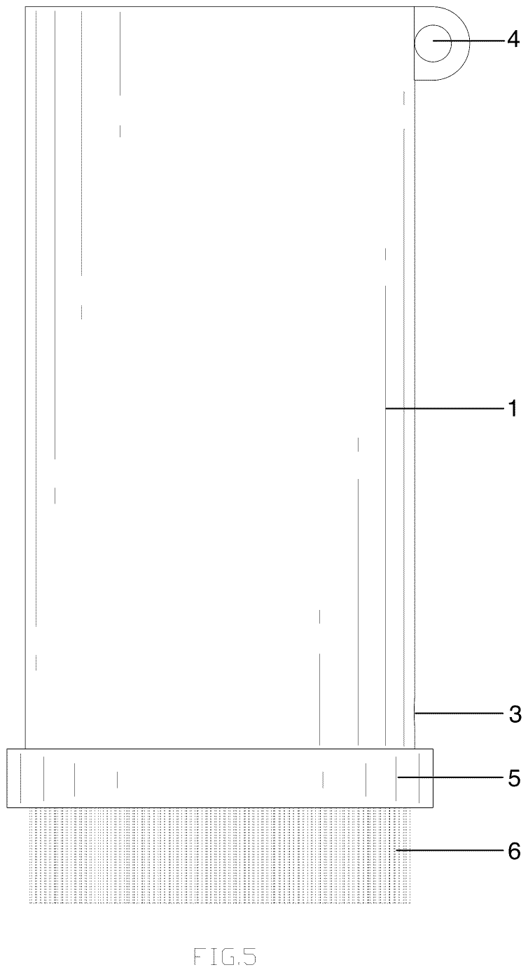

FIG. 6: Right-side view of the cleaning brush, illustrating the hollow cylindrical body (1), air pressure release hole (3), keyring attachment (4), bristle base (5), and bristles (6).

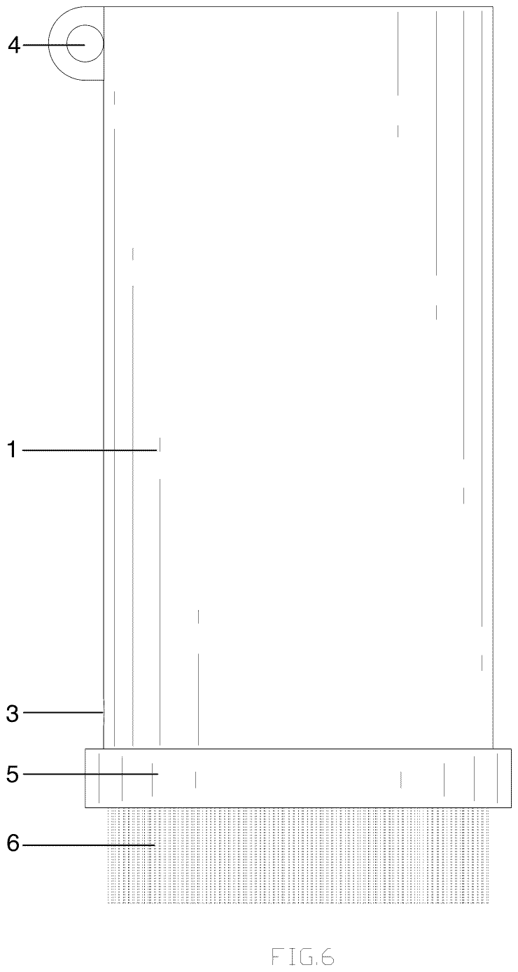

FIG. 7: Top view of the cleaning brush, showing the hollow cylindrical body (1), bottle holster opening (2), keyring attachment (4), and bristle base (5).

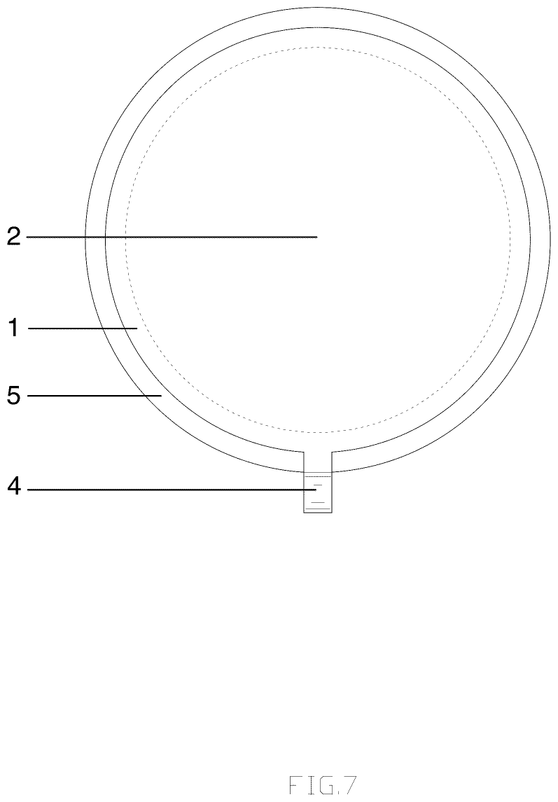

FIG. 8: Bottom view of the cleaning brush, illustrating the keyring attachment (4), bristle base (5), and bristles (6). The air pressure release hole (3) is not visible in this view.

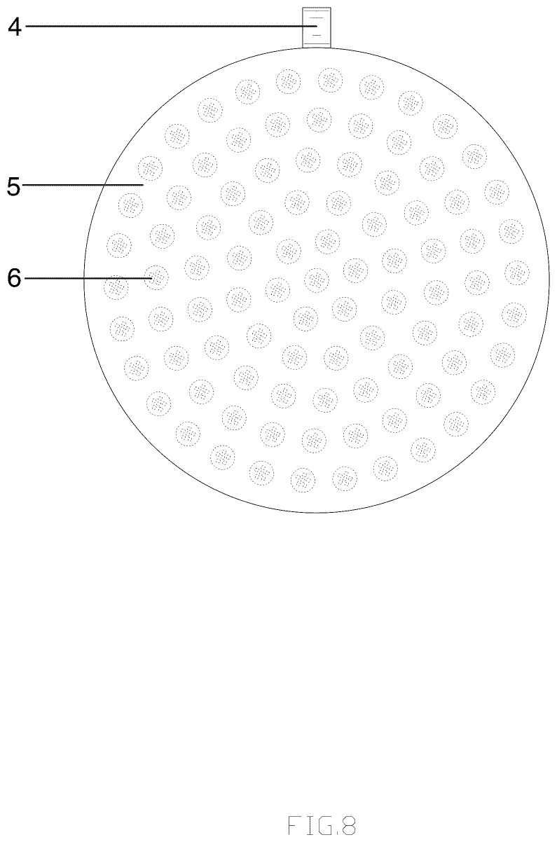

FIG. 9: Exploded view of the cleaning brush system, showing the hollow cylindrical body (1), cleaning solution bottle (7), and elastic securing mechanism (8). The elastic securing mechanism (8), such as a rubber band or O-ring, is positioned around the neck of the bottle (7) to stabilize it within the hollow cylindrical body (1). Arrows indicate the assembly process, showing how the bottle (7) is inserted into the bottle holster opening (2) of the hollow cylindrical body (1), with the elastic securing mechanism (8) ensuring a tight fit.

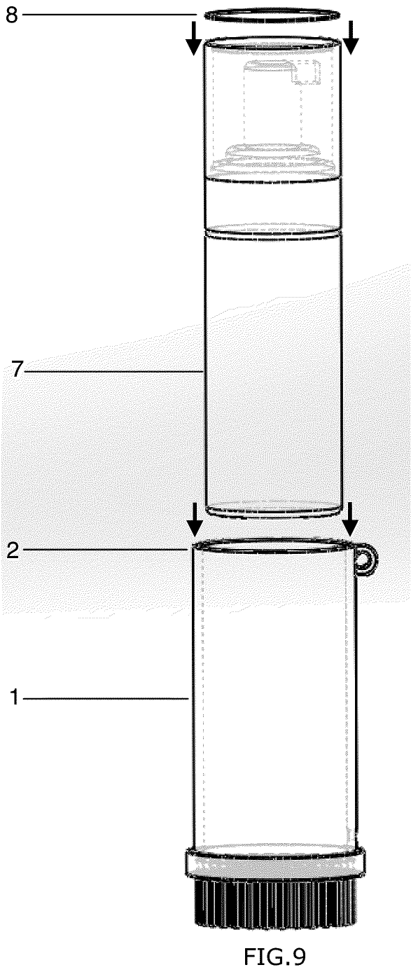

### DETAILED DESCRIPTION OF THE INVENTION

The invention is a cleaning brush with a hollow cylindrical body designed to hold a cleaning solution container securely. The hollow body also serves as a handle and includes an air pressure release hole near its base to allow smooth insertion of the bottle by releasing trapped air.

A bristle base, located at the bottom of the hollow body, is designed to clean various surfaces, including sports equipment, footwear, industrial tools, and other cleaning applications. The brush also includes a keyring attachment at the top for portability, allowing it to be clipped onto a golf bag, work belt, or carried easily.

To enhance functionality, the design incorporates an optional elastic securing mechanism, such as a rubber band, O-ring, or equivalent feature, that can be placed around the cleaning solution bottle. This mechanism stabilizes the bottle within the hollow body and prevents unintended movement during use. The brush is constructed from durable materials such as plastic or aluminum, making it suitable for long-term use in outdoor, industrial, and high-performance environments.

1. A cleaning brush comprising:
A hollow cylindrical body configured to securely hold a cleaning solution container;
A bristle base positioned at the bottom of the cylindrical body, with bristles arranged to clean various surfaces;
An air pressure release mechanism located near the bottom of the cylindrical body, allowing air to escape during bottle insertion and ensuring a secure fit;
A keyring attachment integrated into the body for portability;
Materials selected from plastic, aluminum, or other durable options suitable for long-term use and outdoor environments; and
An elastic securing mechanism, such as a rubber band, O-ring, or equivalent feature, configured to stabilize the cleaning solution container within the hollow cylindrical body to prevent unintended movement or detachment.

2. The cleaning brush of claim 1, wherein the bristle base is circular but may also take on other geometric configurations to suit different cleaning applications.

3. The cleaning brush of claim 1, wherein the air pressure release mechanism further comprises a plug or stopper to stabilize the cleaning solution container.

4. The cleaning brush of claim 1, wherein the hollow body is dimensionally flexible to accommodate variations in bottle size and shape.

5. The cleaning brush of claim 1, wherein the keyring attachment is adaptable in orientation and includes configurations such as vertical, horizontal, or rotational placements.

6. The cleaning brush of claim 1, wherein the elastic securing mechanism is detachable and configured to encircle the cleaning solution container, enhancing its stability within the hollow cylindrical body.
